(19) United States
(12) Patent Application Publication
(10) Pub. No.: US 2022/0154028 A1
(43) Pub. Date: May 19, 2022

(54) PRINTING SETS

(71) Applicant: HEWLETT-PACKARD DEVELOPMENT COMPANY, L.P., Spring, TX (US)

(72) Inventors: Zhang-Lin ZHOU, San Diego, CA (US); Xiaoqi ZHOU, San Diego, CA (US)

(73) Assignee: HEWLETT-PACKARD DEVELOPMENT COMPANY, L.P., Spring, TX (US)

(21) Appl. No.: 17/439,236

(22) PCT Filed: Sep. 27, 2019
(86) PCT No.: PCT/US2019/053593

§ 371 Date: Sep. 14, 2021

(51) Int. Cl. C09D 11/54; C08G 18/24; C08G 18/10; C08G 18/75; C08G 18/38; C08K 3/22; C08K 5/42; C08K 5/07; C08F 222/10; C08F 220/56; C08F 220/20; B41J 3/407; D06P 1/52; D06P 1/673; D06P 5/20; D06P 5/30

(52) U.S. Cl. CPC C09D 11/54; D06P 5/30; C08G 18/10; C08G 18/758; C08G 18/3821; C08G 18/3857; C08K 3/22; C08K 5/42; C08K 5/07; C08F 222/102; C08F 220/56; C08F 220/20; B41J 3/4078; D06P 1/5285; D06P 1/6735; D06P 5/2077; C08G 18/246

(57) ABSTRACT

Described herein is a printing set comprising a curable transparent pre-treatment composition and a fixer composition. The curable transparent pre-treatment composition comprises a curable polyurethane, wherein the curable polyurethane comprises a copolymer of a polyisocyanate; a polyol comprising at least one reactive group selected from an acrylate group, a methacrylate group, an acrylamide group, a methacrylamide group, a styrene, an allyl group and a combination thereof; and a chain-terminating compound comprising a monoalcohol or a monoamine. The fixer composition comprises a salt of a cation and an anion. Also described herein is a method of printing on a textile and a printed textile substrate.

In addition to home and office usage, inkjet technology has been expanded to high-speed, commercial and industrial printing. Inkjet printing is a non-impact printing method that utilizes electronic signals to control and direct droplets or a stream of ink. Some commercial and industrial inkjet printers utilize fixed printheads and a moving substrate web in order to achieve high speed printing.

Current inkjet printing technology involves forcing the ink drops through small nozzles by thermal ejection, piezoelectric pressure or oscillation onto the media substrate. Inkjet technology has become a popular way of recording images on various media surfaces (e.g., paper), for a number of reasons, including, low printer noise, capability of high-speed recording and multicolor recording.

Polyurethane dispersions may be added to inkjet inks to improve the durability of the resulting print.

### BRIEF DESCRIPTION OF THE DRAWINGS

FIG. 1 is a schematic representation of a textile padder.

### DETAILED DESCRIPTION

Before the present disclosure is disclosed and described, it is to be understood that this disclosure is not limited to the particular process steps and materials disclosed herein because such process steps and materials may vary somewhat. It is also to be understood that the terminology used herein is used for the purpose of describing particular embodiments. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “carrier fluid”, “carrier liquid,” “carrier,” or “carrier vehicle” refers to the fluid in which pigment particles, resin, charge directors and other additives can be dispersed to form a liquid electrostatic ink composition or liquid electrophotographic ink composition. The carrier liquids may include a mixture of a variety of different agents, such as surfactants, co-solvents, viscosity modifiers, and/or other possible ingredients.

As used herein, “pigment” generally includes pigment colorants, magnetic particles, aluminas, silicas, and/or other ceramics or organo-metallics, whether or not such particulates impart colour. Thus, though the present description primarily exemplifies the use of pigment colorants, the term “pigment” can be used more generally to describe not just pigment colorants, but other pigments such as organometallics, ferrites, ceramics, and so forth.

As used herein, “co-polymer” refers to a polymer that is polymerized from at least two monomers.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “substituted” may indicate that a hydrogen atom of a compound or moiety is replaced by another atom such as a carbon atom or a heteroatom, which is part of a group referred to as a substituent. Substituents include, for example, alkyl, alkoxy, aryl, aryloxy, alkenyl, alkenoxy, alkynyl, alkynoxy, thioalkyl, thioalkenyl, thioalkynyl, thioaryl, and so forth.

As used herein, “heteroatom” may refer to nitrogen, oxygen, halogens, phosphorus, or sulfur.

As used herein, “alkyl”, or similar expressions such as “alk” in alkoxy, may refer to a branched, unbranched, or cyclic saturated hydrocarbon group, which may, in some examples, contain from 1 to about 50 carbon atoms, or 1 to about 40 carbon atoms, or 1 to about 30 carbon atoms, or 1 to about 10 carbon atoms, or 1 to about 5 carbon atoms for example.

The term “aryl” may refer to a group containing a single aromatic ring or multiple aromatic rings that are fused together, directly linked, or indirectly linked (such that the different aromatic rings are bound to a common group such as a methylene or ethylene moiety). Aryl groups described herein may contain, but are not limited to, from 5 to 5 about 50 carbon atoms, or 5 to about 40 carbon atoms, or 5 to 30 carbon atoms or more, and may be selected from, phenyl and naphthyl.

As used herein, “NVS” is an abbreviation of the term “non-volatile solids”.

As used herein, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless otherwise stated, wt. % values are to be taken as referring to a weight-for-weight (w/w) percentage of solids in the ink composition, and not including the weight of any carrier fluid present.

Unless otherwise stated, any feature described herein can be combined with any aspect or any other feature described herein.

In an aspect, there is provided a printing set. The printing set may comprise:

a curable transparent pre-treatment composition comprising:
a curable polyurethane, wherein the curable polyurethane comprises a copolymer of:
   a polyisocyanate;
   a polyol comprising at least one reactive group selected from an acrylate group, a methacrylate group, an acrylamide group, a methacrylamide group, a styrene, an allyl group or a mixture thereof; and
   a chain-terminating compound comprising a monoalcohol or a monoamine;
   and a fixer composition comprising a salt of a cation and an anion.

In another aspect, there is provided a method of printing on a textile. The method of printing on a textile may comprise:

applying a curable transparent pre-treatment composition and a fixer composition to a textile substrate to form a treated textile substrate;

applying an inkjet ink composition to the treated textile substrate; and

curing the curable transparent pre-treatment composition;

wherein the curable transparent pre-treatment composition comprises:
a curable polyurethane, wherein the curable polyurethane comprises a copolymer of:
   a polyisocyanate;
   a polyol comprising at least one reactive group selected from an acrylate group, a methacrylate group, an acrylamide group, a methacrylamide group, a styrene, an allyl group or a mixture thereof; and
   a chain-terminating compound comprising a monoalcohol or a monoamine;
   and

wherein the fixer composition comprises a salt of a cation and an anion.

In a further aspect, there is provided a printed textile substrate. The printed textile substrate may comprise:

a textile substrate having applied thereon:
a cured transparent pre-treatment composition;
a fixer composition; and
an inkjet ink composition;

wherein the cured pre-treatment composition comprises a cured polyurethane comprising a cured copolymer of:
a polyisocyanate;
a polyol comprising at least one reactive group selected from an acrylate group, a methacrylate group, an acrylamide group, a methacrylamide group, a styrene, an allyl group or a mixture thereof; and
a chain-terminating compound comprising a monoalcohol or a monoamine; and

wherein the fixer composition comprises a salt of a cation and an anion.

The surface morphology and processing history of various textiles reduces quality and durability images printed on textiles. Moreover, a printed textile is washed with detergent numerous times during its lifespan, increasing the requirement for durable printed images in comparison to printing on other substrate types. Examples of the methods and products described herein have been found to avoid or at least mitigate at least one of these difficulties. It has been found that example printing sets increase inkjet ink durability and improve image quality on textiles. In particular, the printing sets have been found to increase ink durability on textiles after washing with detergents.

Printing Set

In an aspect, there is provided a printing set. The printing set may comprise a curable transparent pre-treatment composition and a fixer composition.

In some examples, the printing set may further comprise an inkjet ink composition. In some examples, the printing set may comprise a curable transparent pre-treatment composition, a fixer composition and an inkjet ink composition.

Pre-Treatment Composition

The pre-treatment composition may comprise a curable polyurethane. In some examples, the pre-treatment composition may comprise a curable polyurethane dispersed in a liquid carrier, such as water. In some examples, the pre-treatment composition may consist of a curable polyurethane dispersed in a liquid carrier, such as water.

In some examples, the pre-treatment composition is transparent. In some examples, the transparent pre-treatment composition does not contain any pigment, or substantially lacks pigment and thus is a pigment-free composition. The transparent pre-treatment composition may comprise less than 5 wt. % solids of colorant, in some examples, less than 3 wt. % solids of colorant, in some examples, less than 1 wt. % solids of colorant. “Colorant” may be any material that imparts a color to the composition. As used herein, “colorant” includes pigments and dyes, such as those that impart colors, such as black, magenta, cyan, yellow and white to a composition. As used herein, “pigment” generally includes pigment colorants, magnetic particles, aluminas, silicas, and/or other ceramics or organo-metallics. Thus, though the present description primarily exemplifies the use of pigment colorants, the term “pigment” can be used more generally to describe not only pigment colorants, but also other pigments such as organometallics, ferrites, ceramics, and the like.

In some examples, the curable polyurethane may constitute at least 85 wt. % of the solids of the transparent pre-treatment composition, in some examples, at least 90 wt. % of the solids of the transparent pre-treatment composition, in some examples, at least 95 wt. % of the solids of the transparent pre-treatment composition.

In some examples, the liquid carrier comprises any carrier in which the curable polyurethane can be stably dispersed. In some examples, the liquid carrier comprises a main carrier or solvent and a co-carrier or co-solvent. In some examples, the liquid carrier comprises water. In some examples, the main carrier or solvent is water. In some examples, the liquid carrier may consist of water.

In some examples, the co-solvent(s) may be present in the pre-treatment composition in an amount ranging from about 0.1 wt. % to about 30 wt. %. In an example, the co-solvent is present in the pre-treatment composition in an amount of about 10 wt. % based on the total wt. % of the pre-treatment composition. It is to be understood that other amounts outside of this example and range may also be used. Classes of co-solvents that may be used include organic co-solvents, such as aliphatic alcohols, aromatic alcohols, diols, glycol ethers, polyglycol ethers, 2-pyrrolidinones, caprolactams, formamides, acetamides, glycols, and long chain alcohols. Examples of these co-solvents include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C6-C12) of polyethylene glycol alkyl ethers, N-alkyl caprolactams, unsubstituted caprolactams, both substituted and unsubstituted formamides, both substituted and unsubstituted acetamides, and the like. In some examples, the liquid carrier may include 1-(2-hydroxyethyl)-2-pyrrolidone.

Curable Polyurethane

The curable transparent pre-treatment composition may comprise a curable polyurethane. The curable polyurethane may comprise a copolymer of a polyisocyanate; a polyol comprising at least one reactive group selected from an acrylate group, a methacrylate group, an acrylamide group, a methacrylamide group, a styrene, an allyl group or a mixture thereof; and a chain-terminating compound comprising a monoalcohol or a monoamine.

In some examples, the curable polyurethane is present in the curable transparent pre-treatment composition in an amount of up to about 10 wt. % of the total weight of the pre-treatment composition, for example, up to about 9 wt. %, up to about 8 wt. %, up to about 7 wt. %, up to about 6 wt. %, up to about 5 wt. %, up to about 4 wt. %, up to about 3 wt. %, up to about 2 wt. %, or up to about 1 wt. %. In some examples, the curable polyurethane is present in the curable transparent pre-treatment composition in an amount ranging from about 1% to about 10% by weight, for example, about 2% to about 5% by weight, about 3% to about 9% by weight, about 4% to about 8% by weight, about 1% to about 7% by weight, about 3% to about 6% by weight.

In some examples, the curable polyurethane is present in the pre-treatment composition as a dispersion in water, that is, a dispersion of the curable polyurethane in water is added to the carrier liquid to form the curable pre-treatment composition.

In some examples, the curable polyurethane may be formed by synthesising a polyurethane solution (i.e., the polyurethane polymer in an organic solvent), and then ionising and dispersing the polyurethane solution in water to form the curable polyurethane dispersion. The resulting curable polyurethane dispersion includes curable polyurethane, which is water soluble/dispersible. Each of these steps will be discussed further below.

In some examples, the curable polyurethane has a weight average molecular weight of at least about 2000, for example, at least about 2500, at least about 3000 at least about 3100, at least about 3200, at least about 3300, at least about 3400, at least about 3500, at least about 3600, at least about 3700, at least about 3800, at least about 3900, at least about 4000, at least about 4100, at least about 4200, at least about 4300, at least about 4400, at least about 4500, at least about 4600, at least about 4700, at least about 4800, at least about 4900, at least about 5000 at least about 5500, at least about 5000, at least about 4500, at least about 4000, at least about 3500, at least about 3000, at least about 2500, at least about 2000, at least about 1500, or at least about 1000. In some examples, the curable polyurethane has a weight average molecular weight of about 10000 or less, for example, about 9500 or less, about 9000 or less, about 8500 or less, about 8000 or less, about 7500 or less, about 7000 or less, about 6500 or less, about 6000 or less, or about 5500 or less 5000 or less, for example, 4900 or less, 4800 or less, 4700 or less, 4600 or less, 4500 or less, 4400 or less, 4300 or less, 4200 or less, 4100 or less, 4000 or less, 3900 or less, 3800 or less, 3700 or less, 3600 or less, 3500 or less, 3400 or less, 3300 or less, 3200 or less, 3100 or less, or 3000 or less. In some examples, the curable polyurethane has a weight average molecular weight of from about 2000 to about 10000, for example, from about 2500 to about 9500, about 3000 to about 9000, about 3500 to about 8500, about 4000 to about 8000, about 4500 to about 7500, about 5000 to about 7000, about 5500 to about 6500, or about 5500 to about 6000, about 3000 to about 5000, about 3100 to about 4900, about 3200 to about 4800, about 3300 to about 4700, about 3400 to 4600, about 3500 to about 4500 or about 3000 to 4000.

In some examples, the curable polyurethane has a theoretical acid number of from 20 mgKOH/g material to 100 mgKOH/g material, for example, from 30 mgKOH/g material to 90 mgKOH/g material, from 40 mgKOH/g material to 80 mgKOH/g material, from 50 mgKOH/g material to 70 mgKOH/g material, from 20 mgKOH/g material to 60 mgKOH/g material. The theoretical acid number (AN) is calculated by using equation (1).

$$AN = ( \frac{{mG}_{A}}{{E}_{A}} + \frac{{mG}_{B}}{{E}_{B}} ) * 56.11 - 1000 \qquad ( 1 )$$

in which G_{A} is the weight percentage of acidic monomer A, E_{A} is the molecular weight of acidic monomer A; G_{B} is the weight percentage of acidic monomer B, E_{B} is the molecular weight of acidic monomer B; m is the number of acidic groups in monomer A and B is the number of acidic groups in monomer B.

In some examples, the curable polyurethane has a double bond density of from about 1.5 to about 10. The double bond density refers to the number of milimoles of double bonds in 1 g (dry weight) of the curable polyurethane. The double bond density was calculated by using equation (2).

$$\frac{{M}_{A} * {n}_{A} + {M}_{B} * {n}_{B}}{W} * 1000 \qquad ( 2 )$$

in which M_{A} is the number of moles of reactive monomer A, n_{A} is the number of double bonds in monomer A, M_{B} is the number of moles of reactive monomer B, n_{B} is the number of double bonds in monomer B and W is the total weight of all of the monomers used in the polyurethane.

In some examples, the molar ratio of NCO groups to OH groups in the monomers that react to form the curable polyurethane is in the range from 1.2 to 5, for example, 1.3 to 4.5, 1.4 to 4, 1.5 to 3.5, 1.6 to 3, 1.7 to 2.5, 1.8 to 2, or 1.9 to 5.

The curable polyurethane is formed from the following components: a polyisocyanate; a polyol; and chain-terminating compound. In some examples, the curable polyurethane may be a copolymer of a polyisocyanate; a polyol; and a chain-terminating compound.

Polyisocyante

In some examples, the polyisocyanate may be any suitable polyisocyanate. In some examples, the polyisocyanate may have an average of two or more isocyanate groups. In some examples, the polyisocyanate may be a diisocyanate. In some examples, the polyisocyanate may be an aliphatic, cycloaliphatic, araliphatic or aromatic polyisocyanate, as well as products of their oligomers, used alone or in mixtures of two or more. In some examples, the polyisocyanate is an aliphatic polyisocyanate or a cycloaliphatic polyisocyanate.

In some examples, the polyisocyanate may be selected from hexamethylene-1,6-diisocyanate (HDI), 2,2,4-trimethyl-hexamethylene diisocyanate (TMDI), 1,12-dodecane diisocyanate, 2,4,4-trimethylhexamethylene diisocyanate, 2-methyl-1,5-pentamethylene diisocyanate, 2,4,4-trimethyl-hexamethylene diisocyanate, 2-methyl-1,5-pentamethylene diisocyanate, isophorone diisocyanate (IPDI), 4,4′-methylene diphenyl diisocyanate (MDI), 4,4′-methylenebis(cyclohexyl isocyanate) (H12MD1), ortho-, meta- or para-tetramethylxylylene diisocyanate (TMXDI), and combinations thereof.

In some examples, the polyisocyanate has a molecular weight of less than 1000. In some examples, the polyisocyanate has a molecular weight of less than 750, for example less than 500, for example less than 400, for example less than 300. In some examples, the polyisocyanate has a molecular weight of at least 300. In some examples, the polyisocyanate has a molecular weight of at least 400, for example at least 500, for example at least 750, for example at least 1000.

The amount of the polyisocyanate monomer within the polyurethane ranges from about 20 wt. % to about 50 wt. % of the total wt. % of the polyurethane. In an example, polyisocyanate makes up from about 30 wt. % to about 50 wt. % of the polyurethane. In an example, polyisocyanate makes up from about 40 wt. % to about 50 wt. % of the polyurethane.

Polyol

In some examples, the polyol comprises at least one reactive group selected from an acrylate group, a methacrylate group, an acrylamide group, a methacrylamide group, a styrene, an allyl group and a combination thereof. In some examples, the polyol comprises at least two reactive groups selected from an acrylate group, a methacrylate group, an acrylamide group, a methacrylamide group, a styrene, an allyl group or a combination thereof.

As used herein the term polyol may mean any compound having at least two hydroxyl groups. Thus, the polyol comprising at least one reactive group comprises a compound having at least two hydroxyl groups and at least one reactive group.

In some examples, the polyol may be a diol, that is, may be a compound having two hydroxyl groups.

In some examples, the polyol comprises a diol having at least one reactive group selected from an acrylate group, a methacrylate group, an acrylamide group, a methacrylamide group, a styrene, an allyl group and a combination thereof. In some examples, the polyol, for example, the diol, may comprise at least one reactive group selected from an acrylate group, a methacrylate group and combinations thereof.

In some examples, the polyol, for example, the diol, may comprise two reactive groups each independently selected from an acrylate group, a methacrylate group, an acrylamide group, a methacrylamide group, a styrene and an allyl group. In some examples, the polyol, for example, the diol, may comprise two reactive groups each independently selected from an acrylate group and a methacrylate group. In some examples, the each of the reactive groups may be the same or different.

The printing set according to claim 1, wherein the polyol is a diol selected from formulae I, II, III, and IV, and combinations thereof:

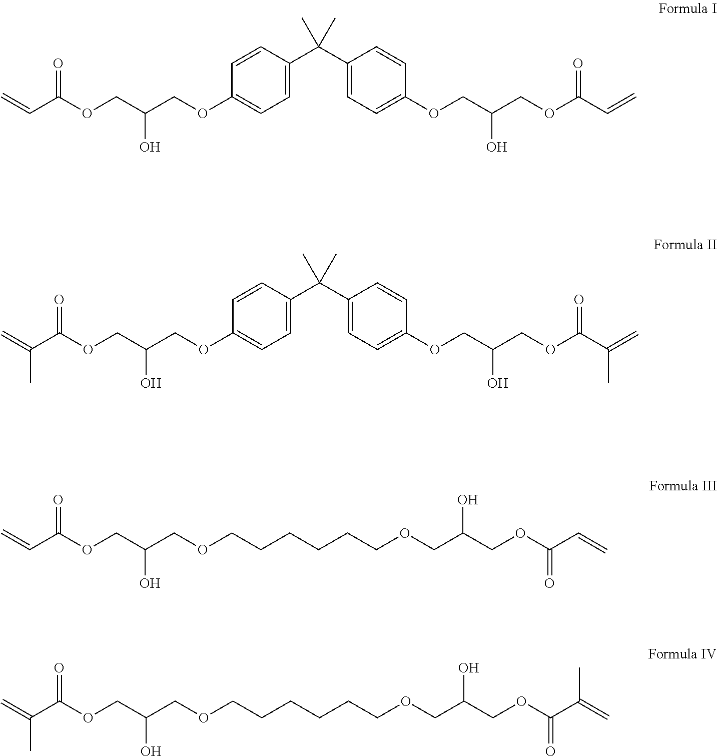

The reactive group(s) in the polyol render the polyurethane curable, for example, by heat, ultraviolet light or any other suitable electromagnetic radiation. Additionally, the reactive group(s) in the polyol increase the double bond density of the polyurethane and improves the curing efficiency.

In some examples, the amount of polyol monomer within the polyurethane ranges from about 10 wt. % to about 50 wt. % based on the total wt. % of the curable polyurethane. In another example, the amount of polyol monomer within the polyurethane ranges from about 20 wt. % to about 40 wt. % based on the total wt. % of the curable polyurethane, for example in an amount ranging from about 30 wt. % to about 40 wt. % of the total weight % of the curable polyurethane.

In some examples, the weight ratio of the polyol to the chain-terminating compound may be from about 0.5:1 to about 3:1, for example, about 1:1 to about 2:1, for example, about 1.5:1 to about 2.5:1.]

Chain-Terminating Compound

In some examples, the chain-terminating compound comprises a monoalcohol or a monoamine. In some examples, the polyurethane is formed by reacting the polyisocyanate and the polyol comprising at least one reactive group to form a pre-polymer and then reacting the pre-polymer with the chain-terminating compound.

In some examples, the chain-terminating compound comprises a monoalcohol, a monoamine or a combination thereof. In some examples, the chain-terminating compound comprises a monoalcohol. In some examples, the chain-terminating compound comprises a monoamine.

In some examples, the chain-terminating compound comprises a reactive chain-terminating compound or a stabilising chain-terminating compound. In some examples, the chain terminating compound comprises a mixture of a reactive chain terminating compound and a stabilising chain-terminating compound.

In some examples, the reactive chain-terminating compound comprises (in addition to the hydroxyl or amino group) at least one reactive group selected from an acrylate group, a methacrylate group, an acrylamide group, a methacrylamide group, a styrene, an allyl group or a mixture thereof. In some examples, the reactive chain-terminating compound comprises one, two or three reactive groups selected from an acrylate group, a methacrylate group, an acrylamide group, a methacrylamide group, a styrene, an allyl group or a combination thereof.

In some examples, the reactive chain-terminating compound comprises a hydroxyalkyl acrylate, a hydroxyalkyl methacrylate, a hydroxylalkyl acrylamide, a hydroxyalkyl methacrylamide, a glycerol diacrylate, a glycerol dimethacrylate, a glycerol diacrylamide, a glycerol dimethacrylamide, pentaerythritol triacrylate, pentaerythritol trimethacrylate, a hydroxy allylether, or a glycerol diallylether. In some examples, an alkyl group may be a C1 to C5 alkyl group, for example, a C1, C2 or C3 alkyl group.

In some examples, the reactive chain-terminating compound comprises a compound selected from Formulae V to IX and combinations thereof:

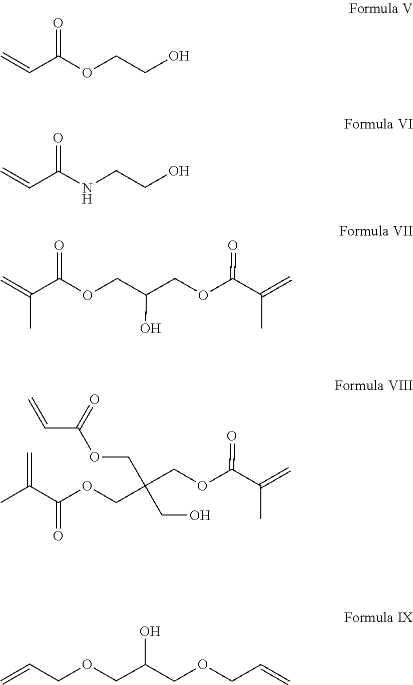

In some examples, the stabilising chain-terminating compound comprises (in addition to the hydroxyl or amino group) a carboxylic acid, a sulfonic acid or both. In some examples, the stabilising chain-terminating compound comprises a carboxylic acid. In some examples, the stabilising chain-terminating compound comprises a sulfonic acid.

In some examples, the stabilising chain-terminating compound comprises a compound selected from selected from amino acids (for example, naturally occurring amino acids or synthetic compounds containing an amino group and a carboxylic acid containing, for example, 1 to 20 carbon atoms), taurine, 3-(cyclohexylamino)-1-propanesulfonic acid (CAPS), 2-(cyclohexylamino)ethanesulfonic acid (CHES) and combinations thereof.

In some examples, the chain-terminating compound comprises a mixture of a reactive chain-terminating compound and a stabilising chain terminating compound. In some examples, the polyurethane is formed by reacting the polyisocyanate and the polyol comprising at least one reactive group to form a pre-polymer and then reacting the pre-polymer with the reactive chain-terminating compound to form a further pre-polymer before reacting the further pre-polymer with the stabilising chain-terminating compound.

In some examples, the chain-terminating compound comprises a reactive chain-terminating compound wherein the monoalcohol or monoamine comprising an acrylate group, a methacrylate group, an acrylamide group, a methacrylamide group, a styrene, an allyl group or a mixture thereof; and a stabilising chain-terminating compound wherein the monoalcohol or monoamine comprises a carboxylic acid or a sulfonic acid.

In some examples, the amount of chain-terminating compound within the polyurethane ranges from about 10 wt. % to about 50 wt. % based on the total wt. % of the curable polyurethane. In another example, the amount of chain-terminating compound within the polyurethane ranges from about 20 wt. % to about 40 wt. % based on the total wt. % of the curable polyurethane, for example in an amount ranging from about 30 wt. % to about 40 wt. % of the total weight % of the radiation curable polyurethane.

In some examples, the weight ratio of the reactive chain-terminating compound to the stabilising chain-terminating compound may be from about 1:1 to about 3:1, for example, about 1.5:1 to about 2.5:1, about 1:1 to about 2:1.

Fixer Composition

In some examples, the fixer composition may comprise a salt of a cation and an anion. In some examples, the fixer composition may comprise a salt of a cation and an anion; and a liquid carrier. In some examples, the liquid carrier may be the same as or different from the liquid carrier of the pre-treatment composition.

In some examples, the cation is a monovalent metal cation or a multivalent cation. In some examples, the multivalent cation may be a multivalent metal cation or a multivalent organic cation.

In some examples, the cation is a metal cation. In some examples, the metal cation may be a monovalent metal cation or a multivalent metal cation. In some examples, the metal cation may be a multivalent metal cation.

In some examples, the liquid carrier may comprise a solvent and a co-solvent. In some examples, the liquid carrier may comprise water. In some examples, the liquid carrier may consist of water.

In some examples, the salt is an inorganic metallic salt or an organic metallic salt.

In some examples, the inorganic metallic salt may be a water-soluble salt of a metal cation and an anion. In some examples, the organic metallic salt may be a water-soluble salt of a metal cation and an organic anion.

In some examples, the metal cation may be a Group I metal cation, a Group II metal cation, a Group III metal cation or a transition metal cation. In some examples, the multivalent cation may be a Group II metal cation, a Group III metal cation or a transition metal cation. In some examples, the metal cation may be selected from cations of sodium, potassium, calcium, copper, nickel, magnesium, zinc, barium, iron, aluminium and chromium.

In some examples, the anion of the inorganic metallic salt may be selected from chloride, iodide, bromide, nitrate, sulfate, sulfite, phosphate, chlorate, acetate and combinations thereof.

In some examples, the anion of the organic metallic salt may be carboxylates (for example, alkyl carboxylates with 1 to 35 carbon atoms). In some examples, the metallic carboxylate may be in a hydrated form having from 1 to 20 water molecules attached to the salt molecules. In some examples, the organic metallic salt may be selected from calcium acetate monohydrate, calcium propionate, calcium propionate hydrate, calcium formate and mixtures thereof.

In some examples, the multivalent cation may comprise a molecule having multiple positively charged centres, each of which may be singly or multiply charged. In some examples, this multivalent cation may be a cationic polymer. In some examples, a cationic polymer may have cationic groups forming part of the repeating unit of the polymer.

In some examples, the cationic polymer may be a naturally occurring polymer such as cationic gelatin, cationic dextran, cationic chitosan, cationic cellulose, or cationic cyclodextrin. In some examples, the cationic polymer may be a synthetically modified naturally occurring polymer such as modified chitosan, for example, carboxymethyl chitosan or N,N,N-trimethyl chitosan chloride.

In some examples, the cationic polymer may be a polymer having cationic groups as part of the main polymer chain, such as in an alkoxylated quaternary polyamine having the structure of formula X:

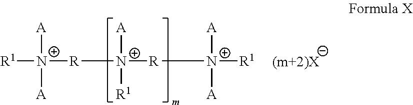

wherein R, R¹ and A may be the same or different and may be selected from linear or branched C₂-C₁₂ alkylene, C₃-C₁₂ hydroxyalkylene, C₄-C₁₂ dihydroxyalkylene, or dialkylarylene and X may be any suitable counterion, such as a halogen or other similarly charged anions; and m may be an integer such that the polymer has a weight average molecular weight in the range of from 100 Mw to 8000 Mw. In some examples, all of the nitrogen atoms may be quaternary.

In some examples, the cationic polymer may be a polymer having pendant ionic groups, such as quaternized poly(4-vinyl pyridine), which has structure of formula XI:

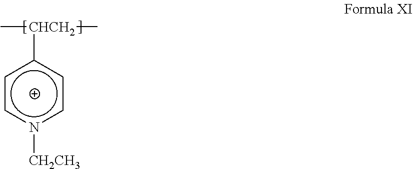

wherein the anion may be a halogen, for example, bromide, and the polymer may have a weight average molecular weight in the range of from 100 Mw to 8000 Mw.

In some examples, the cationic polymer may be a cationic polyamine, for example, cationic polyacrylate diamines, quaternary ammonium salts, cationic polyoxyethylenated amines, quaternized polyoxyethylenated amines, cationic polydicyandiamides, polydiallyldimethyl ammonium chloride polymeric salts, or quaternized dimethylaminoethyl(meth)acrylate polymers.

In some examples, the cationic polymer may be a cationic polyimine, such as linear cationic polyethyleneimines, branched cationic polyethyleneimines, or quaternized polyethylenimines.

In some examples, the cationic polymer may be a substituted polyuria, such as cationic poly[bis(2-chloroethyl)ether-alt-1,3 bis[3-(dimethylamino)propyl]urea], or quaternized poly[bis(2 chloroethyl)ether-alt-1,3-bis [3-(dimethylamino)propyl].

In some examples, the cationic polymer may be a vinyl polymer, such as quaternized vinylimidazol, modified cationic vinylalcohol, or alkylguanidine.

In some examples, the fixer composition may comprise about 90 wt. % or more liquid carrier, for example, about 91 wt. % or more, about 92 wt. % or more, about 93 wt. % or more, about 94 wt. % or more, about 95 wt. % or more, about 96 wt. % or more, about 97 wt. % or more, about 98 wt. % or more, or about 99 wt. % or more liquid carrier. In some examples, the fixer composition may comprise about 99 wt. % or less liquid carrier, for example, about 98 wt. % or less, about 97 wt. % or less, about 96 wt. % or less, about 95 wt. % or less, about 94 wt. % or less, about 93 wt. % or less, about 92 wt. % or less, about 91 wt. % or less, or about 90 wt. % or less liquid carrier. In some examples, the fixer composition may comprise about 90 wt. % to about 99 wt. % liquid carrier, about 91 wt. % to about 98 wt. %, about 92 wt. % to about 97 wt. %, about 93 wt. % to about 96 wt. %, or about 94 wt. % to about 95 wt. % liquid carrier.

In some examples, the fixer composition may comprise about 1 wt. % or more salt, for example, about 2 wt. % or more, about 3 wt. % or more, about 4 wt. % or more, about 5 wt. % or more, about 6 wt. % or more, about 7 wt. % or more, about 8 wt. % or more, about 9 wt. % or more, or about 10 wt. % or more salt. In some examples, the fixer composition may comprise about 10 wt. % or less salt, for example, about 9 wt. % or less, about 8 wt. % or less, about 7 wt. % or less, about 6 wt. % or less, about 5 wt. % or less, about 4 wt. % or less, about 3 wt. % or less, about 2 wt. % or less, or about 1 wt. % or less salt. In some examples, the fixer composition may comprise about 1 wt. % to about 10 wt. %, about 2 wt. % to about 9 wt. %, about 3 wt. % to about 8 wt. %, about 4 wt. % to about 7 wt. %, or about 5 wt. % to about 6 wt. % salt.

Inkjet Ink Composition

In some examples, the printing set further comprises an inkjet ink composition. In some examples, the inkjet composition comprises a polymer, a colorant, a liquid carrier and, optionally, additives, such as, a UV absorber and a surfactant. In some examples, the polymer is a polyurethane, for example, a curable polyurethane as described above. In some examples, the inkjet ink composition may comprise any curable polyurethane described herein. In some examples, the inkjet ink composition may comprise a curable polyurethane, a pigment and a carrier liquid. In some examples, the carrier liquid may be the same as or different from the carrier liquid in the pre-treatment composition. In some examples, the carrier liquid may comprise water.

In some examples, the colorant may be a self-dispersed pigment, a pigment in a dispersion including water and a polymer that disperses the pigment (i.e., a polymer dispersant). In some examples, the pigment dispersion may include a co-solvent, such as 2-pyrolidone. The pigment dispersion may be prepared or purchased and the other components of the inkjet ink composition may be added slowly to the pigment dispersion with continuous mixing to form the inkjet ink composition.

The pigment may be any color, including, for example, a cyan pigment, a magenta pigment, a yellow pigment, a black pigment, a violet pigment, a green pigment, a brown pigment, an orange pigment, a purple pigment, a white pigment, a metallic pigment (e.g., a gold pigment, a bronze pigment, a silver pigment, or a bronze pigment), a pearlescent pigment, or combinations thereof. Any suitable pigment may be used, and while several examples are provided herein, it is to be understood that the list is non-limiting.

Examples of suitable blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:34, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of suitable magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 167, C.I. Pigment Yellow 172, C.I. Pigment Yellow 180, and C.I. Pigment Yellow 185.

Carbon black may be a suitable inorganic black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN®5750, RAVEN®5250, RAVEN®5000, RAVEN®3500, RAVEN®1255, and RAVEN®700); various carbon black pigments of the REGAL® series, the MOGUL® series, or the MONARCH® series manufactured by Cabot Corporation, Boston, Mass., (such as, e.g., REGAL®400R, REGAL®330R, REGAL®660R, MOGUL®E, MOGUL®L, AND ELFTEX®410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX®35, PRINTEX®U, PRINTEX®V, PRINTEX®140U, Special Black 5, Special Black 4A, and Special Black 4). An example of an organic black pigment includes aniline black, such as C.I. Pigment Black 1.

Some examples of green organic pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45.

Examples of brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, and C.I. Pigment Orange 66.

A suitable metallic pigment includes a metal chosen from gold, silver, platinum, nickel, chromium, tin, zinc, indium, titanium, copper, aluminum, and alloys of any of these metals. These metals may be used alone or in combination with two or more metals or metal alloys. Some examples of metallic pigments include STANDART® R0100, STANDART® R0200, and DORADO® gold-bronze pigments (available from Eckart Effect Pigments, Wesel, Germany).

The total amount of pigment in the inkjet ink composition may range from about 1 wt. % to about 5 wt. % (based on the total wt. % of the inkjet ink composition).

In some examples, the inkjet ink composition comprises a UV absorber. In some examples, the UV-LED absorber may be a compound of formula XII:

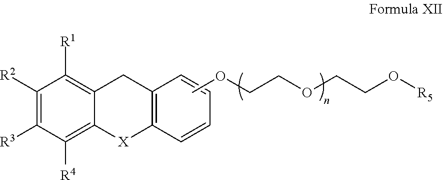

wherein R¹, R², R³, R⁴, and R⁵ are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, a substituted or unsubstituted aralkyl group, a halogen atom, —NO₂, —O—R^{d}, —CO—R^{d}, —CO—O—R^{d}, —O—CO—R^{d}, —CO—NR^{d}R^{e}, —NR^{d}R^{e}, —NR^{d}—CO—R^{e}, —NR^{d}—CO—O—R^{e}, —NR^{d}—CO—NR^{e}R^{f}, —SR^{d}, —SO—R^{d}, —SO₂—R^{d}, —SO₂—O—R^{d}, —SO₂NR^{d}R^{e} and a perfluoroalkyl group. R^{d}, R^{e}, and R^{f} are each independently selected from the group consisting of a hydrogen atom, a substituted or unsubstituted alkyl group, a substituted or unsubstituted allyl group, a substituted or unsubstituted alkene or alkenyl group, a substituted or unsubstituted aryl group, and a substituted or unsubstituted aralkyl group. Some examples of suitable alkyl groups include methyl, ethyl, propyl, isopropyl, butyl, isobutyl, pentyl, hexyl, and the like. One example of a suitable alkene group is ethylene. Some examples of suitable aryl groups include phenyl, phenylmethyl, and the like. In formula XII, X is O, S, or NH and the polyether chain has n is an integer in the range of from 1 to 200.

In some examples, the UV absorber may be present in an amount of 0.1 wt. % to about 10 wt. % of the inkjet ink composition. In some examples, the UV absorber is absent.

In some examples, the inkjet ink composition may also include a surfactant(s). As an example, the inkjet ink composition may include non-ionic, cationic, and/or anionic surfactants, which may be present in an amount ranging from about 0.01 wt. % to about 5 wt. % based on the total wt. % of the inkjet ink composition. In at least some examples, the inkjet ink composition may include a silicone-free alkoxylated alcohol surfactant such as, for example, TEGO® Wet 510 (Evonik Tego Chemie GmbH) and/or a self-emulsifiable wetting agent based on acetylenic diol chemistry, such as, for example, SURFYNOL® SE-F (Air Products and Chemicals, Inc.). Other suitable commercially available surfactants include SURFYNOL® 465 (ethoxylated acetylenic diol), CARBOWET® GA-21 1 (a.k.a. SURFYNOL® CT-211, non-ionic, alkylphenylethoxylate and solvent free), and SURFYNOL® 104 (non-ionic wetting agent based on acetylenic diol chemistry) (all of which are from Air Products and Chemicals, Inc.); ZONYL® FSO (a.k.a. CAPSTONE®, which is a water-soluble, ethoxylated non-ionic fluorosurfactant from Dupont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Co.).

The inkjet ink composition may also include an anti-kogation agent. Kogation refers to the deposit of dried ink on a heating element of a thermal inkjet printhead. Anti-kogation agent(s) is/are included to assist in preventing the buildup of kogation. Examples of suitable anti-kogation agents include oleth-3-phosphate (commercially available as CRODAFOS® O3A or CRODAFOS® N-3 acid from Croda Int.) or dextran 500k. Other suitable examples of the anti-kogation agents include CRODAFOS® HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), and the like.

The anti-kogation agent may be present in the inkjet ink composition in an amount ranging from about 0.05 wt. % to about 2 wt. % of the total wt. % of the inkjet ink composition.

In some examples, the inkjet ink composition may also include antimicrobial agent(s) (biocide(s)), viscosity modifier(s), material(s) for pH adjustment, sequestering agent(s), preservative(s), jettability additive(s) (e.g., liponic ethylene glycol (LEG-1), available from Liponics), and the like.

When a biocide is utilized, a suitable amount of the biocide may range from about 0.05 wt. % to about 0.5 wt. % of a total wt. % of the inkjet ink composition. In some examples, the biocide is present at about 0.18 wt. %, or at about 0.14 wt. % of a total wt. % of the inkjet ink composition. It is to be understood that the upper limit for the biocide(s) may depend upon the type of biocide and its toxicological effect and/or regulatory requirements. For example, the upper limit for PROXEL® GXL (Arch Chemicals, Inc., Norwalk, Conn.) is 0.2 wt. %. Suitable biocides include, for example, PROXEL® GXL, KORDEK® MLX (The Dow Chemical Co.), and/or BIOBAN® CS-1246 (The Dow Chemical Co.).

Method of Making a Pre-Treatment Composition

In some examples, a method of making a pre-treatment composition comprises dispersing a curable polyurethane in a liquid carrier. In some example, the method of making a pre-treatment composition may comprise combining a curable polyurethane and a base with a liquid carrier and stirring.

In some examples, the method of making a pre-treatment composition comprise polymerising a polyisocyanate, a polyol and a chain-terminating compound to form a curable polyurethane and dispersing the curable polyurethane in a liquid carrier.

In some examples, the method of making a pre-treatment composition comprises forming a curable polyurethane.

In some examples, forming a curable polyurethane comprises reacting a polyisocyanate, a polyol and a chain-terminating agent to form a curable polyurethane.

In some examples, forming a curable polyurethane comprises reacting a polyisocyanate and a polyol to form a pre-polymer; and reacting the pre-polymer with a chain-terminating compound to form a curable polyurethane. In some examples, forming a curable polyurethane comprises reacting a polyisocyanate and a polyol to form a pre-polymer; and reacting the pre-polymer with a reactive chain-terminating compound to form a curable polyurethane. In some examples, forming a curable polyurethane comprises reacting a polyisocyanate and a polyol to form a pre-polymer; and reacting the pre-polymer with a stabilising chain-terminating compound to form a curable polyurethane. In some examples, the forming a curable polyurethane comprises reacting a polyisocyanate and a polyol to form a first pre-polymer; reacting the first pre-polymer with a reactive chain-terminating compound to form a second pre-polymer with a stabilising chain-terminating agent to form a curable polyurethane.

In some examples, reaction with the stabilising chain-terminating agent occurs in the presence of a base.

In some examples, the polymerisation is performed in the presence of an inhibitor, for example, 4-methoxyphenol. In some examples, the inhibitor prevents polymerisation of the reactive group of the monomers. Other suitable inhibitors include 4-tert-butylpyrocatechol, tert-butylhydroquinone, 1,4-benzoquinone, 6-tert-butyl-2,4-xylenol, 2-tert-butyl-1,4-benzoquinone, 2,6-di-tert-butyl-p-cresol, 2,6-di-tert-butylphenol, 1,1-diphenyl-2-picrylhydrazyl, hydroquinone, and phenothiazine.

In some examples, polymerisation occurs at 100° C. or less, for example, 90° C. or less, 80° C. or less, 70° C. or less, 60° C. or less. In some examples, the reaction of the polyisocyanate with the polyol occurs at a higher temperature (e.g., 60° C.) than the reaction of the pre-polymer with the chain-terminating compound (e.g., 50° C. or 40° C.). In some examples, the reaction of the pre-polymer with the reactive chain-terminating compound occurs at a higher temperature than the reaction of the pre-polymer with the stabilising chain-terminating compound.

In some examples, no isocyanate groups remain in the curable polyurethane.

Method of Making a Fixer Composition

In some examples, the method of making the fixer composition comprises dispersing the salt in the carrier liquid.

Method of Printing a Textile

In an aspect, there is provided a method of printing on a textile. In some examples, the method of printing on a textile comprises applying a curable transparent pre-treatment composition and a fixer composition to a textile substrate to form a treated textile substrate; applying an inkjet ink composition to the treated textile substrate; and curing the curable transparent pre-treatment composition.

In some examples, the method of printing on a textile comprises applying a curable transparent pre-treatment composition and a fixer composition to a textile substrate to form a treated textile substrate; applying an inkjet ink composition to the treated textile substrate; and curing the curable transparent pre-treatment composition; wherein the curable transparent pre-treatment composition comprises a curable polyurethane, wherein the curable polyurethane comprises a copolymer of a polyisocyanate; a polyol comprising at least one reactive group selected from an acrylate group, a methacrylate group, an acrylamide group, a methacrylamide group, a styrene, an allyl group or a mixture thereof; and a chain-terminating compound comprising a monoalcohol or a monoamine; and wherein the fixer composition comprises a salt of a multivalent cation and an anion.

In some examples, the pre-treatment composition may be applied to the textile substrate before the fixer composition. In some examples, the fixer composition may be applied to the textile substrate before the pre-treatment composition.

In some examples, the pre-treatment composition is applied to the textile substrate, the fixer composition is applied to the pre-treatment composition and the inkjet ink composition is applied to the fixer composition. In some examples, the fixer composition is applied to the textile substrate, the pre-treatment composition is applied to the fixer composition and the inkjet ink composition is applied to the pre-treatment composition.

In some examples, the method of printing on a textile is a wet-on-wet printing method. In some examples, the method of printing comprises applying the inkjet ink composition onto the pre-treatment composition before the pre-treatment composition has dried. In some examples, the method of printing on a textile comprises applying the inkjet ink composition onto the fixer composition before the fixer composition has dried. In some examples, the method of printing on a textile comprises applying the fixer composition onto the pre-treatment composition before the pre-treatment composition has dried. In some examples, the method of printing on a textile comprises applying the pre-treatment composition onto the fixer composition before the fixer composition has dried.

In some examples, the method of printing on a textile comprise applying the pre-treatment composition to a textile, applying the fixer composition to the pre-treatment composition before the pre-treatment composition has dried; and applying the inkjet ink composition to the fixer composition before either the pre-treatment composition or the fixer composition has dried.

In some examples, the method of printing on a textile comprises applying the pre-treatment composition to a textile and allowing the pre-treatment composition to dry; applying the fixer composition to the pre-treatment composition and allowing the fixer composition to dry; and applying the inkjet ink composition to the fixer composition.

In some examples, the pre-treatment composition is applied by any suitable technique. In some examples, the pre-treatment composition is applied by a textile padder, or by using spray coating, gravure coating, flexo coating, rod coating, film coating, reverse roll coating, screen coating, offset printing or digital printing, for example, inkjet printing.

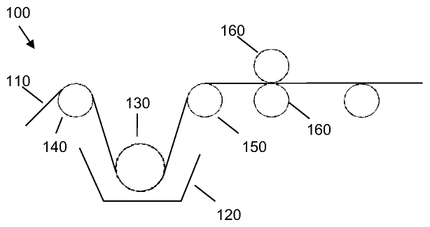

FIG. 1 shows a schematic illustration of a textile padder (100). A textile (110) is fed through a container (120) of the pre-treatment composition around a roller (130). The tension of the textile (110) is controlled by a pair of rollers (140 and 150). After the textile (110) has been saturated with the pre-treatment composition in the container (120), the textile (110) is fed through a nip between a pair of rollers (160 and 170) at a constant speed. The pair of rollers forming the nip (that is, rollers 160 and 170) may apply a controlled pressure to squeeze excess pre-treatment composition from the textile and ensure the desired coat weight of the pre-treatment composition is applied to the textile.

In some examples, the pre-treatment composition is applied in an amount such that the dry coat weight is 0.5 g/m² to 10 g/m², for example, 1 g/m² to 5 g/m², or 1.5 g/m² to 3 g/m².

In some examples, the fixer composition is applied by any suitable technique. In some examples, the fixer composition is applied by a textile padder or by using spray coating, gravure coating, flexo coating, rod coating, film coating, reverse roll coating, screen coating, offset printing or digital printing, for example, inkjet printing. A textile padder applies the fixer composition in the same way as described for the pre-treatment composition.

In some examples, the fixer composition is applied in an amount such that the dry coat weight is 0.1 g/m² to 2 g/m², for example, 0.2 g/m² to 1.5 g/m², or 0.5 g/m² to 1 g/m².

In some examples, the inkjet ink composition is applied in an amount such that the ink amount jetted is between 30 ng and 50 ng, for example, 15 ng to 45 ng or 30 ng to 40 ng.

In some examples, curing the curable transparent pre-treatment composition comprises heating. In some examples, curing the curable transparent pre-treatment composition comprises heating to a temperature of at least about 100° C., for example, at least about 125° C., at least about 150° C., at least about 175° C., at least about 200° C., at least about 225° C., at least about 250° C., at least about 275° C., at least about 300° C., at least about 325° C., at least about 350° C., at least about 375° C., or at least about 400° C. In some examples, curing the curable transparent pre-treatment composition comprises heating to a temperature of about 400° C. or less, for example, about 375° C. or less, about 350° C. or less, about 325° C. or less, about 300° C. or less, about 275° C. or less, about 250° C. or less, about 225° C. or less, about 200° C. or less, about 175° C. or less, about 150° C. or less, about 125° C. or less, or about 100° C. or less. In some examples, curing the curable transparent pre-treatment composition comprises heating to a temperature of about 100° C. to about 400° C., about 125° C. to about 375° C., about 150° C. to about 350° C., about 175° C. to about 325° C., about 200° C. to about 300° C., about 225° C. to about 275° C., or about 250° C. to about 400° C. In some examples, the heating is performed for 10 min or less, for example, about 9 min or less, about 8 min or less, about 7 min or less, about 6 min or less, about 5 min or less, about 4 min or less, about 3 min or less, about 2 min or less, or about 1 min or less. In some examples, the heating is performed for 5 s or more, for example, about 10 s or more, about 15 s or more, about 20 s or more, about 25 s or more, about 30 s or more, about 35 s or more, about 40 s or more, about 45 s or more, about 50 s or more, about 55 s or more, about 1 min or more, about 2 min or more, about 3 min or more, about 4 min or more, about 5 min or more, about 6 min or more, about 7 min or more, about 8 min or more, about 9 min or more, or about 10 min or more. In some examples, the heating is performed for about 5 s to about 10 min, about 10 s to about 9 min, about 15 s to about 8 min, about 20 s to about 7 min, about 25 s to about 6 min, about 30 s to about 5 min, about 35 s to about 4 min, about 40 s to about 3 min, about 45 s to about 2 min, about 50 s to about 1 min, or about 55 s to about 1 min.

In some examples, curing the curable transparent pre-treatment composition comprises irradiating, for example, irradiation with UV irradiation. In some examples, the UV irradiation is in the range of 10 nm to 400 nm. In some examples, the irradiation is at a wavelength of 300 nm to 400 nm, for example, 395 nm. In some examples, irradiation is performed for 20 min or less, for example, 15 min or less or 10 min or less. In some examples, irradiation is performed for 1 min or more, for example, 5 min or more or 10 min or more. In some examples, irradiation is performed in pulses, for example, 1 to 30 pulses, 5 to 25 pulses, 10 to 20 pulses, or 15 to 30 pulses. In some example, each pulse may be for 10 s or more, for example, 15 s or more, 20 s or more, or 30 s or more. In some examples, each pulse may be for 1 min or less, for example, 50 s or less, 40 s or less, or 30 s or less. In some examples, each pulse may be for 10 s to 1 min, for example, 15 s to 50 s, 20 s to 40 s, or 25 s to 30 s.

In some examples, the method further comprises curing the inkjet ink composition. In some examples, curing the inkjet ink composition occurs simultaneously with curing the pre-treatment composition.

In some examples, curing the pre-treatment composition cures the curable polyurethane, forming a cured polyurethane. Curing the pre-treatment composition may cause the reactive groups of the polyol, and, if present, the reactive chain-terminating, to react, cross-linking the polyurethane. In some examples, the polyurethane may cross-link with other molecules of polyurethane, either in the pre-treatment composition or in the inkjet ink composition. In some examples, the polyurethane may cross-link with the surface of the textile.

Printed Textile

In an aspect, there is provided a printed textile substrate. In some examples, the printed textile may comprise a textile substrate having applied thereon: a cured transparent pre-treatment composition; a fixer composition; and an inkjet ink composition.

In some examples, the printed textile may comprise a textile substrate having applied thereon: a cured transparent pre-treatment composition; a fixer composition; and an inkjet ink composition; wherein the cured pre-treatment composition comprises a cured polyurethane comprising a cured copolymer of: a polyisocyanate; a polyol comprising at least one reactive group selected from an acrylate group, a methacrylate group, an acrylamide group, a methacrylamide group, a styrene, an allyl group or a mixture thereof; and a chain-terminating compound comprising a monoalcohol or a monoamine; and wherein the fixer composition comprises a salt of a multivalent cation and an anion.

In some examples, the printed textile may comprise a textile substrate; a cured transparent pre-treatment composition disposed on the textile substrate; a fixer composition disposed on the pre-treatment composition; and an inkjet ink composition disposed on the fixer composition.

In some examples, the printed textile may comprise a textile substrate; a fixer composition disposed on the textile; a cured transparent pre-treatment composition disposed on the fixer composition; and an inkjet ink composition disposed on the pre-treatment composition.

In some examples, the printed textile may comprise a textile substrate; and an inkjet ink composition disposed on the textile substrate; wherein the textile substrate has been saturated with a pre-treatment composition and a fixer composition.

Textile Substrate

The textile substrate may be any suitable textile or fabric substrate. The textile substrate may be a network of natural or synthetic fibres. The textile substrate may be woven or non-woven. The textile substrate may be formed of yarns, for example, spun threads or filaments, which may be natural or synthetic material or a combination thereof. The textile substrate may include substrates that have fibres that may be natural and/or synthetic. The textile substrate may comprise any textile, fabric material, fabric clothing, or other fabric product onto which it is desired to apply printed matter.

The term “textile” includes, by way of example, cloth, fabric material, fabric clothing or other fabric products. The textile structure may have warp and weft yarns. The terms “warp” and “weft” refer to weaving terms that have their ordinary meaning in the textile arts, that is, warp refers to lengthwise or longitudinal yarns on a loom whereas weft refers to crosswise or transverse yarns on a loom. The textile substrate may be woven, non-woven, knitted, tufted, crocheted, knotted, and/or have a pressed structure.

It is notable that the term “textile” or “fabric” substrate does not include materials commonly known as any kind of paper. Paper takes the form of sheets, rolls and other physical forms which are made of various plant fibres (like trees) or a mixture of plant fibres with synthetic fibres laid down on a fine screen from a suspension in water.

The textile or fabric substrate may also be called a bottom supporting substrate or textile or fabric supporting substrate. The word “supporting” also refers to a physical objective of the substrate, which is to carry the printed image.

Furthermore, textile substrates include both textiles in filament form, in the form of fabric material, or even in the form of fabric that has been crafted into a finished article (such as clothing, blankets, tablecloths, napkins, bedding material, curtains, carpet, shoes). In some examples, the textile substrate has a woven, knitted, non-woven or tufted structure.

The textile substrate may be a woven fabric in which warp yarns and weft yarns are mutually positioned at an angle of about 90°. The woven fabric may include, but is not limited to, fabric with a plain weave structure, fabric with a twill weave structure in which the twill weave structure produces diagonal lines on a face of the fabric, or a satin weave. The textile substrate may be a knitted fabric with a loop structure including one or both of a warp-knit fabric and a weft-knit fabric. A weft-knit fabric refers to a knitted fabric in which the loops in the fabric structure that are formed from a separate yarn are mainly introduced in a longitudinal fabric direction. A warp-knit fabric refers to a knitted fabric in which the loops in the fabric structure that are formed from a separate yarn are mainly introduced in a transverse fabric direction. The textile substrate may also be a non-woven product, for example, a flexible fabric that includes a plurality of fibres or filaments that are one or both of bonded together and interlocked together by a chemical treatment process (e.g., a solvent treatment), a mechanical treatment process (e.g., embossing), a thermal treatment process, or a combination of two or more of these processes.

The textile substrate may include one or both of natural fibres and synthetic fibres. Natural fibres that may be used include, but are not limited to, wool, cotton, silk, linen, jute, flax or hemp. Additional fibres that may be used include, but are not limited to, rayon fibres, or thermoplastic aliphatic polymeric fibres derived from renewable resources, including but not limited to, corn starch, tapioca products, or sugarcanes. These additional fibres may be referred to as “natural” fibres. In some examples, the fibres used in the textile substrate include a combination of two or more from the above-listed natural fibres, a combination of any of the above-listed natural fibres with another natural fibre or with a synthetic fibre, or a mixture of two or more from the above-listed natural fibres, or a mixture of any thereof with another natural fibre or with a synthetic fibre.

Synthetic fibres that may be used include polymeric fibres including, but not limited to, polyvinyl chloride (PVC) fibres, polyester (such as polyethylene terephthalate, or poly-butylene terephthalate), polyamide, polyimide, polyacrylic, polypropylene, polyethylene, polyurethane, polystyrene, polyaramid (e.g., Kevlar®), polytetrafluoroethylene (e.g., Teflon®) (both trademarks of E. I. du Pont de Nemours and Company), fibreglass, polytrimethylene and polycarbonate. In some examples, the fibre used in the textile substrate includes a combination of two or more of the fibres, a combination of any of the fibres with another polymeric fibre or with a natural fibre, a mixture of two or more of the fibres, or a mixture of any of the fibres with another polymer fibre or with a natural fibre. In some examples, the synthetic fibre includes modified fibres. The term “modified fibres” refers to one or both of the polymeric fibre and the fabric as a whole having undergone a chemical or physical process such as, but not limited to, one or more of a copolymerisation with monomers or other polymers, a chemical grafting reaction to contact a chemical functional group with one or both the polymeric fibre and a surface of the fabric, a plasma treatment, a solvent treatment, for example, acid etching, and a biological treatment, for example, an enzyme treatment or antimicrobial treatment to prevent biological degradation. In some examples, the textile substrate is PVC-free. The term “PVC-free” means no polyvinyl chloride polymer or vinyl chloride monomer units are in the textile substrate. In some examples, the textile substrate is a synthetic polyester fibre or is formed from a synthetic polyester fibre.

The textile substrate may contain both natural fibres and synthetic fibres. In some examples, the amount of synthetic fibres represents from about 20% to about 90% of the total amount of fibres. In some other examples, the amount of natural fibres represents from about 10% to about 80% of the total amount of fibres. In some examples, the textile substrate comprises natural fibres and synthetic fibres in a woven structure, the amount of natural fibres is about 10% of a total fibre amount and the amount of synthetic fibres is about 90% of the total fibre amount. The textile substrate may further contain additives including, but not limited to, one or more of, for example, colorant (e.g., pigments, dyes, tints), antistatic agents, brightening agents, nucleating agents, antioxidants, UV stabilizers, fillers and lubricants. Alternatively, the textile substrate may be pre-treated in a solution containing the substances listed above before applying the primer to form the primer layer.

Examples of textiles include synthetic fabrics, such as polyethylene terephthalate (PET), nylon, and/or polyester. The synthetic fabric may be a woven or non-woven fabric. In one example, a PET substrate is coated, for example, on one (e.g., back or front) or both sides with a coating, such as nylon and/or polyester. An example of a two-side-coated PET fabric is Product code 7280N, available from Cole Fabrics Far East, which is a white dip-coated nylon/polyester blend taffeta with a slit edge.

### EXAMPLES

The following illustrates examples of the methods and other aspects described herein. Thus, these Examples should not be considered as limitations of the present disclosure, but are merely in place to teach how to make examples of the present disclosure.

### Example 1—Pre-Treatment Composition

A diol containing two acrylate groups (33.545 g, BGDA (Formula I)), an inhibitor (0.335 g, 4-methoxyphenol (MEHQ)), a diisocyanate (43.585 g, 4,4′-methylene dicyclohexyl diisocyanate (H12MD1)), and a solvent (42 g, acetone) were mixed in a 500 ml of 4-neck round bottom flask. A mechanical stirrer with glass rod and Teflon blade was attached. A condenser was attached. The flask was immersed in a constant temperature bath at 60° C. The system was kept under a drying tube containing a calcium sulfate dessicant (Drierite). A catalyst (3 drops, dibutyltin dilaurate (DBTDL)) was added to initiate the polymerization. Polymerization was continued for 3 hrs at 60° C. Samples (0.5 g) of this pre-polymer were withdrawn for % NCO titration to confirm the reaction had occurred. The measured % NCO value was 10.35%. The theoretical % NCO for this reaction is 10.55%.

A reactive chain-terminating compound (15.939 g, HEAA (Formula VI—N-hydroxylethyl acrylamide, CAS #7646-67-5, purchased from Sigma Aldrich)), an inhibitor (0.159 g, MEHQ), and a solvent (19 g, acetone) were mixed in a beaker and then added to the reactor over 30 s. Additional solvent (9 g, acetone) was used to rinse the residual monomers from the beaker into the reactor. The polymerization was continued 3 hours at 50° C. A sample (0.5 g) of this pre-polymer was withdrawn for % NCO titration. The measured NCO value was 2.45%. The theoretical % NCO for this reaction is 2.50%.

The polymerization temperature was reduced to 40° C. A stabilising chain-terminating compound (6.931 g, taurine), a base (4.652 g, 50% NaOH), and deionised water (34.653 g) were mixed in a beaker until the taurine had completely dissolved. The taurine solution was then added to the pre-polymer solution, which was at 40° C. with vigorous stirring over 1-3 mins. The solution became viscous and slightly hazy. Stirring was continued for 30 mins at 40° C. The mixture became clear and viscous after 15-20 mins at 40° C. Cold deionised water (197.381 g) was added to the polymer mixture in 4-neck round bottom flask over 1-3 mins with good agitation to form the polyurethane dispersion. Agitation was continued for a further 60 mins at 40° C. The polyurethane dispersion was filtered through a 400 mesh (37 μm) stainless steel sieve. Acetone was removed with a rotorvap at 50° C. (add 2 drops (20 mg) BYK-011 de-foaming agent). The final polyurethane dispersion was filtered through fiberglass filter paper. The average particle size (as measured by using a Malvern Zetasizer) is 32.6 nm. As used herein, the average particle size is the Z-average, which is the intensity weighted mean hydrodynamic size of the ensemble collection of particles measured by dynamic light scattering (DLS). The pH was 7.5. The solid content was 29.08%. This polyurethane dispersion (PUD) shows a 0.47 unit pH drop after 1 week accelerated shelf life (ASL). The ASL is achieved by placing the composition in an oven (at about 60° C.) for 1 week and the properties of the composition are then compared with those measured initially.

The viscosity of the pre-treatment composition was approximately 3 cP to 5 cP (3 mPa·s to 5 mPa·s).

Procedure for Determining the % NCO

The samples were dissolved in acetone with the help of a mechanical agitator, and then added to a 250 mL Erlenmeyer flask with a stopper. Di-n-butylamine solution (20 mL, 0.1 N, acetone) was added by using a pipette. After swirling for 15 min, bromophenol blue indicator solutions (4-6 drops) were added. Two titrations were performed with hydrochloridic acid (0.1 N) until a yellow color end point was observed. Simultaneously, the comparison titrations were run including all of the reagents but omitting the samples. The NCO content was then calculated by using the following equation

$$NCO , \% = \frac{( {V}_{O} - V ) \times C \times 42.02}{M \times 1000} \times 100$$

in which V_{O} is the volume (mL) of HCl solution required for the titration of 20 mL di-n-butylamine in acetone solution (the comparison solution); V is the volume (mL) of HCl solution required for the titration of the sample; C is the molar concentration of the HCl solution used; M is the weight of the sample (in g); and 42.02 is the equivalent weight of isocyanate group (in g/mol). The titration was repeated three times for each sample and the results were averaged to give the % NCO content.

### Example 2—Pre-Treatment Composition

A pre-treatment composition was prepared according to the procedure of example 1, except for the following changes:

The initial polymerisation stage was performed by using 38.884 g of BGDA, 0.389 g of MEHQ, 42.103 g of H12MD1, and 42 g of acetone. The measured % NCO value was 7.6%. The theoretical % NCO is 8.32%.

The first chain-terminating stage of the polymerisation was performed by using 12.318 g of HEAA, 0.159 g of MEHQ, and 19 g of acetone. The measured % NCO value was 2.41%. The theoretical % NCO is 2.41%.

The second chain-terminating stage of the polymerization was performed by using 6.695 g of taurine, 4.494 g of 50% NaOH, and 33.474 g of deionized water. The amount of cold deionised water added was 194.649 g.

The particle size (as measured by using a Malvern Zetasizer) is 26.8 nm. The pH was 6.0. The solid content was 30.04%. This PUD shows a 0.13 unit pH drop after 1 week ASL.

The viscosity of the pre-treatment composition was approximately 3 cP to 5 cP (3 mPa·s to 5 mPa·s).

### Example 3—Pre-Treatment Composition

A pre-treatment composition was prepared according to the procedure of Example 1 except for the following changes:

The initial polymerisation stage was performed by using 33.732 g of BGDA, 0.337 g of MEHQ, 40.176 g of H12MD1, 3.095 g of isophorone diisocyanate (IPDI) and 42 g of acetone. The measured % NCO value was 10.32%. The theoretical % NCO is 10.63%.

The first chain-terminating stage of the polymerisation was performed by using 16.028 g of HEAA, 0.160 g of MEHQ, and 19 g of acetone. The measured % NCO value was 2.49%. The theoretical % NCO is 2.51%.

The second chain-terminating stage of the polymerisation was performed by using 6.969 g of taurine, 4.678 g of 50% NaOH, and 34.846 g of deionized water. The amount of cold deionised water added was 197.314 g.

The particle size (as measured by using a Malvern Zetasizer) is 25.5 nm. The pH was 7.4. The solid content was 30.0%. This PUD shows a 0.19 unit pH drop after 1 week ASL.

The viscosity of the pre-treatment composition was approximately 3 cP to 5 cP (3 mPa·s to 5 mPa·s).

### Example 4—Pre-Treatment Composition

A pre-treatment composition was prepared according to the procedure of Example 1 except for the following changes:

The initial polymerisation stage was performed by using 22.288 g of BGDA, 0.223 g of MEHQ, 36.199 g of H12MD1 and 30 g of acetone. The measured % NCO value was 13.19%. The theoretical % NCO for this reaction is 13.21%.

The first chain-terminating stage of the polymerisation was performed by using 26.244 g of HPBMA (Formula VII—glycerol 1,3-dimethacrylate), 0.262 g of MEHQ, and 19 g of acetone. The measured % NCO value was 3.40%. The theoretical % NCO for this reaction is 3.42%.

The second chain-terminating stage of the polymerisation was performed by using 15.269 g of CAPS (3-(cyclohexylamino)-1-propanesulfonic acid), 5.795 g of 50% NaOH, and 38.172 g of deionized water. The amount of cold deionised water added was 186.374 g.

The particle size (as measured by using a Malvern Zetasizer) is 18.98 nm. The pH was 7.5. The solid content was 28.21%. This PUD shows a 0.25 unit pH drop after 1 week ASL.

The viscosity of the pre-treatment composition was approximately 3 cP to 5 cP (3 mPa·s to 5 mPa·s).

### Example 5—Pre-Treatment Composition

A pre-treatment composition was prepared according to the procedure of Example 1 except for the following changes:

The initial polymerisation stage was performed by using 22.506 g of BGDA, 0.225 g of MEHQ, 36.553 g of H12MD1 and 30 g of acetone. The measured % NCO value was 13.19%. The theoretical % NCO for this reaction is 13.21.

The first chain-terminating stage of the polymerisation was performed by using 26.500 g of HPBMA, 0.265 g of MEHQ, and 19 g of acetone. The measured % NCO value was 3.41%. The theoretical % NCO for this reaction is 3.42%.

The second chain-terminating stage of the polymerisation was performed by using 14.441 g of CHES (2-(cyclohexylamino)ethansesulfonic acid), 5.852 g of 50% NaOH, and 38.102 g of deionized water. The amount of cold deionised water added was 187.6144 g. The particle size (as measured by using a Malvern Zetasizer) is 21.93 nm. The pH was 7.0. The solid content was 27.22%. This polyurethane dispersion shows a 0.15 unit pH drop after 1 week ASL.

The viscosity of the pre-treatment composition was approximately 3 cP to 5 cP (3 mPa·s to 5 mPa·s).

### Example 6—Fixer Composition

Ca(NO₃)₂ was dissolved in deionised water to form a solution containing 5 wt. % to 15 wt. % Ca(NO₃)₂.

### Example 7—Inkjet Ink Compositions

Inkjet ink compositions comprising a reactive polyurethane dispersion were prepared by combining a 6 wt. % of reactive polyurethane dispersion (CPUD-470, 1 wt. % UV absorber M-TX-PEG-550, 6 wt. % of glycerol, 0.5 wt. % of crodafos N3 acid (oleth-3 phosphate, a wetting agent available from Croda), 1 wt. % of LEG-1 (Liponic EG-1, a humectant and lubricant available from Vantage Specialty Ingredients comprising 26 mol of an ethoxylate of glyverine), 0.22 wt. % of aticide B20 (a glycol based benzisothiazolinone, a microbiocide available from Thor), 0.3 wt. % of Surfynol 440 (a surfactant available from Evonik™), 3.75 wt. % of magenta pigment dispersion (SYMULER® FAST MAGENTA Series) and a balance of water. The viscosity of the ink composition was approximately 3.5 cPoise (3.5 mPa·s).

UV absorber M-TX-PEG-550 has the following chemical structure:

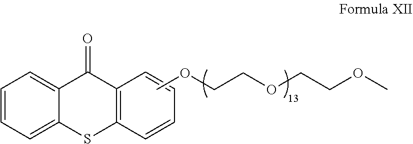

### Examples 8—Printed Images

A pre-treatment composition according to Example 5 was applied by the Lab textile padder (by Mathis AG, Switzerland) with a pressure of 50 psi (approximately 0.345 MPa) to a fabric (100% cotton) in an amount suitable to form a layer of curable transparent pre-treatment composition with a dry coat weight of 2.5 g/m². The fabric was then allowed to dry at 120° C. for 10 min.

A fixer composition according to Example 6 was applied with a textile padder at a pressure of 50 psi (approximately 0.345 MPa) to the pre-treatment composition in an amount suitable to form a layer of fixer composition with a dry coat weight of 1 to 2 g/m². The fabric was then allowed to dry at 120° C. for 5 min.

Images were then printed on the fixer composition by using an Innovator durability plot (3 dpp ink) and an A4025 pen. The curable polyurethanes of the pre-treatment composition and the inkjet ink composition were then simultaneously cured by heating at either 150° C. over 3 min or 200° C. for 30 s or by irradiation under a 395 nm LED for different numbers of pulses, each pulse lasting 30 s.

### Example 9—Printed Images

Inkjet printed images were prepared according to Example 8 except that the fabric used was a 50:50 mixture of cotton and polyester.

Test Results

The durability of the printed images was tested after 5 washing cycles using a conventional washing machine (Whirlpool, model 589-01) on a 40° C., 50 min washing cycle with a detergent (Tide liquid detergent). The printed fabrics were air dried between washing cycles. The optical density (OD; measured with an X-Rite spectrophotometer) and La*b* before and after the washes. The results are given in Table 1. ΔE is calculated with the following equation. A smaller value for ΔE indicates a smaller change in optical density.

ΔE=\sqrt{(ΔL*)²+(Δa*)₊²(Δb*)²}

TABLE 1

| | 5 LED pulses | | 10 LED pulses | | 15 LED pulses | | 20 LED pulses | |
|---|---|---|---|---|---|---|---|---|
| | | ΔE | | ΔE | | ΔE | | ΔE |
| | Initial | after | Initial | after | Initial | after | Initial | after |
| | OD | 5 washes | OD | 5 washes | OD | 5 washes | OD | 5 washes |
| Ex 8 | 1.19 | 4.9 | 1.22 | 3.9 | 1.2 | 4.7 | 1.24 | 3.4 |
| Ex 9 | 1.12 | 5.6 | 1.12 | 5.3 | 1.16 | 3.6 | 1.17 | 4.2 |

The use of the combination of the pre-treatment composition and fixer composition results in improved image quality as measured by ink optical density on the surface of the textile and improved image durability as measured by washing the printed images multiple times in a washing machine with a detergent. The Example printed textiles show increased optical density compared with reference textiles printed without the use of the pre-treatment composition. Additionally, the Example printed textiles show reduced colour bleeding and coalescence/puddling.

While the compositions and methods have been described with reference to certain examples, those skilled in the art will appreciate that various modifications, changes, omissions, and substitutions can be made without departing from the spirit of the disclosure. It is intended, therefore, that the compositions and methods be limited by the scope of the following claims. Unless otherwise stated, the features of any dependent claim can be combined with the features of any of the other dependent claims and any of the independent claims.

1. A printing set comprising:
a curable transparent pre-treatment composition comprising:
a curable polyurethane, wherein the curable polyurethane comprises a copolymer of:
a polyisocyanate;
a polyol comprising at least one reactive group selected from an acrylate group, a methacrylate group, an acrylamide group, a methacrylamide group, a styrene, an allyl group and a combination thereof; and
a chain-terminating compound comprising a monoalcohol or a monoamine; and
a fixer composition comprising a salt of a cation and an anion.

2. The printing set according to claim 1, wherein the chain-terminating compound comprises a reactive chain-terminating compound wherein the monoalcohol or monoamine comprises at least one reactive group selected from an acrylate group, a methacrylate group, an acrylamide group, a methacrylamide group, a styrene, an allyl group or a mixture thereof.

3. The printing set according to claim 1, wherein the chain-terminating compound comprises stabilising chain-terminating compound wherein the monoalcohol or monoamine comprises a carboxylic acid or a sulfonic acid.

4. The printing set according to claim 1, wherein the chain-terminating compound comprises
a reactive chain-terminating compound wherein the monoalcohol or monoamine comprising an acrylate group, a methacrylate group, an acrylamide group, a methacrylamide group, a styrene, an allyl group or a mixture thereof; and
a stabilising chain-terminating compound wherein the monoalcohol or monoamine comprises a carboxylic acid or a sulfonic acid.

5. The printing set according to claim 1, wherein the polyol comprises a diol.

6. The printing set according to claim 1, wherein the polyisocyanate is a diisocyanate selected from hexamethylene-1,6-diisocyanate (HDI), 2,2,4-trimethyl-hexamethylenediisocyanate (TMDI), 1,12-dodecane diisocyanate, 2,4,4-trimethylhexamethylene diisocyanate, 2-methyl-1,5-pentamethylene diiso-cyanate, isophorone diisocyanate (IPDI), 4,4′-methylene diphenyl diisocyanate (MDI), 4,4′-methylenebis(cyclohexyl isocyanate) (H12MD1), ortho-, meta- or para-tetramethylxylylene diisocyanate (TMXDI), and combinations thereof.

7. The printing set according to claim 1, wherein the polyol is a diol selected from formulae I, II, III, and IV, and combinations thereof:

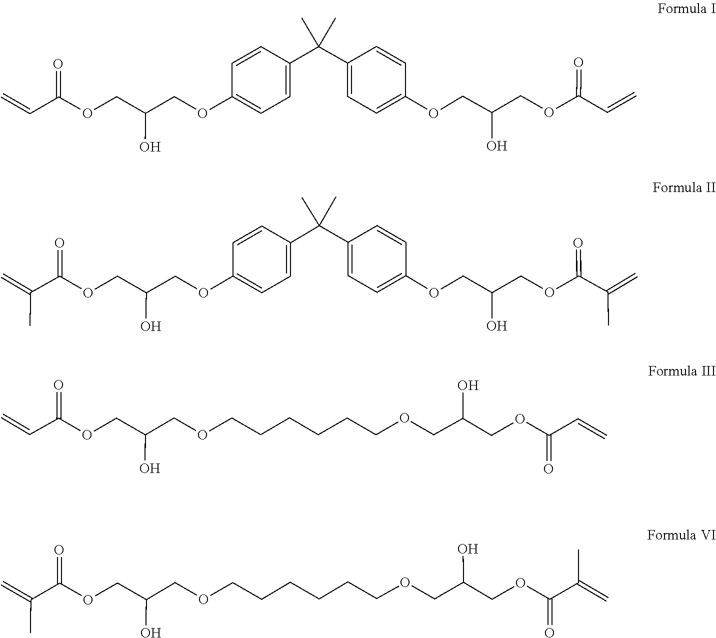

8. The printing set according to claim 2, wherein the reactive chain-terminating compound comprises a compound selected from Formulae V to IX and combinations thereof:

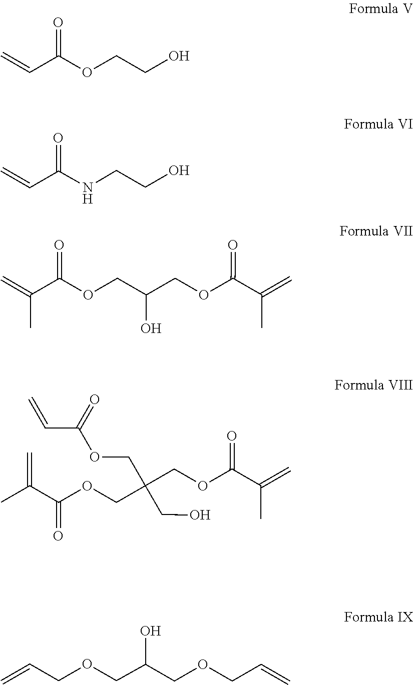

9. The printing set according to claim 3, wherein the stabilising chain-terminating compound comprises a compound selected from amino acids, taurine, 3-(cyclohexylamino)-1-propanesulfonic acid (CAPS), 2-(cyclohexylamino)ethanesulfonic acid (CHES) and combinations thereof.

10. The printing set according to claim 1, wherein the curable polyurethane has a weight average molecular weight of from about 2000 to about 10000.

11. The printing set according to claim 1, wherein the curable polyurethane has a double bond density of from about 1.5 to about 10.

12. The printing set according to claim 1, wherein the molar ratio of NCO groups to OH groups in the monomers that have reacted to form the curable polyurethane is in the range from 1.2 to 5.

13. The printing set according to claim 1, further comprising an inkjet ink composition.

14. A method of printing on a textile comprising:
applying a curable transparent pre-treatment composition and a fixer composition to a textile substrate to form a treated textile substrate;
applying an inkjet ink composition to the treated textile substrate; and
curing the curable transparent pre-treatment composition;
wherein the curable transparent pre-treatment composition comprises:
a curable polyurethane, wherein the curable polyurethane comprises a copolymer of:
a polyisocyanate;
a polyol comprising at least one reactive group selected from an acrylate group, a methacrylate group, an acrylamide group, a methacrylamide group, a styrene, an allyl group and a combination thereof; and
a chain-terminating compound comprising a monoalcohol or a monoamine; and
wherein the fixer composition comprises a salt of a cation and an anion.

15. A printed textile substrate comprising:
a textile substrate having applied thereon:
a cured transparent pre-treatment composition;
a fixer composition; and
an inkjet ink composition;
wherein the cured pre-treatment composition comprises a cured polyurethane comprising a cured copolymer of:
a polyisocyanate;
a polyol comprising at least one reactive group selected from an acrylate group, a methacrylate group, an acrylamide group, a methacrylamide group, a styrene, an allyl group and a combination thereof; and
a chain-terminating compound comprising a monoalcohol or a monoamine; and
wherein the fixer composition comprises a salt of a cation and an anion.
